(19) United States
(12) Patent Application Publication
(10) Pub. No.: US 2005/0239442 A1
(43) Pub. Date: Oct. 27, 2005

(54) Method and system for handling wireless messaging errors

(75) Inventors: Xuming Chen, San Ramon, CA (US); Jerry Kupsh, Concord, CA (US); David D'Englere, Concord, CA (US)

Correspondence Address: DARBY & DARBY P.C., P. O. BOX 5257, NEW YORK, NY, 10150-5257, US

(73) Assignee: Cellco Partnership d/b/a Verizon Wireless, Bedminster, NJ (US)

(21) Appl. No.: 10/816,589

(22) Filed: Mar. 31, 2004

(51) Int. Cl. H04Q 7/20

(52) U.S. Cl. 455/412.2

(57) ABSTRACT

A method and system for handling wireless messaging errors is provided. When an error occurs during the attempted retrieval of a message, it is classified as temporal or permanent. In the event of a permanent error the message is abandoned. In the event of a temporal error, the message is placed in a waiting state. A first retry is attempted after a first waiting period has elapsed. If the first retry is unsuccessful, subsequent retries are attempted thereafter, wherein each retry attempt is attempted after a corresponding period of time has passed since the previous retry attempt. If at any time a message is successfully sent or received, an opportunity retry is attempted for each pending message without waiting the required waiting period, provided that the mobile phone is available.

### FIELD OF THE INVENTION

This invention relates generally to Multimedia messaging over wireless networks and more specifically to a method and system for handling transmission errors in Multimedia messaging over wireless networks.

### BACKGROUND OF THE INVENTION

Multimedia Messaging Services (also known in the art as “MMS”) is an emerging field of cellular telephony. Multimedia Messaging Services allow a user to send and receive multimedia messages to/from cellular mobile phones. Multimedia messages may include video, audio, photographs, or other multimedia type information.

An MMS message is sent or received using a data connection (such as a 1× CDMA connection of the known CDMA 2000 standard incorporated by reference herein). Because data connections are relatively expensive in terms of spectrum used, many MMS providers ask the recipient of an MMS message to approve the reception of the message before the data connection is initiated, and the MMS message is sent subsequent to the approval. Thus, transmission of unwanted messages is avoided. This method includes an additional benefit—many wireless providers bill their users at least partially based on the number of MMS messages received. Allowing the subscriber to approve or decline receipt of a message ensures that a user will not have to receive and pay for unwanted messages.

The request for approval of the reception of an MMS message is usually sent to the recipient via Short Messaging Services (also known in the art as “SMS”), e.g., as defined by TIA/EIA-637-B incorporated by reference herein. SMS is a messaging standard well known in the art for providing text messaging capabilities to mobile phones. SMS may be used for the transmission of short binary messages as well. When a wireless system receives an MMS message destined for a particular recipient R, it usually saves the message at a central location and sends out to R's mobile phone, an SMS message signifying that an MMS message has been received. The SMS message is usually in binary format and usually contains some information describing the MMS message, such as an identifier associated with the sender (usually a phone number) subject line of the MMS message, and the size of the MMS message.

Once R's mobile phone receives the SMS notification message, it alerts its user R, that an MMS message is waiting for him/her, and displays any relevant available information describing the MMS message. User R can initiate download of the MMS message to his/her mobile phone or simply ignore it. Alternatively, some mobile phones.

If the user chooses to initiate download of the MMS message, the mobile phone attempts to establish a data connection to download the message. Because of the nature of wireless communications, the download of the MMS message may fail for a variety of reasons. For example, there may be electromagnetic interference that prevents a data connection from being set up. Alternatively, there may be so many ongoing data connections in a certain area, that there is insufficient bandwidth for a new connection. Even if a connection can be established, the MMS message may not be able to be retrieved because of a problem with the MMS servers of the wireless network.

Currently, there are two commonly used approaches to dealing with such errors. According to the first approach, the mobile phone simply alerts the user that there has been a communications problem and suggests the user attempt message retrieval at a later time. There are problems with this approach. Having to attempt retrieval of an MMS message multiple times tends to create an impression in the mind of the user that the user is receiving substandard service. Furthermore, having to make multiple attempts to download a single MMS message may prove to be an annoyance for the user. A user that is being billed per MMS message received may also be worried that each unsuccessful attempt is costing the user money.

Notwithstanding the above mentioned difficulties, this approach only addresses temporal problems with the wireless network. Temporal problems are problems that can be expected to be resolved after the passage of time, such as lack of available spectrum or unusually high interference. There are, however, permanent errors which may prevent the transmission of an MMS message to the user. An example of such a problem is an unexpected loss of the actual MMS message that is to be downloaded from the wireless network's MMS servers. If a permanent error is present, and the user is asked to try again, the user will likely make multiple unsuccessful and unnecessary attempts to receive the MMS message.

The second approach is to provide the user with an interface which allows the user to browse from the user's mobile phone a storage space at a remote server where the pending MMS messages for that user are held. This approach is problematic because it exposes the user to a layer of MMS messaging which is preferably hidden from the user. Exposing the user to the concept of server side storage may cause confusion with local (i.e., mobile phone based) storage of messages and drive users away from using MMS messaging.

### SUMMARY

The present invention is directed to a method and system for handling wireless messaging errors. The method differentiates between two types of errors—temporal and permanent. Temporal errors are handled by scheduling a limited number of retries, i.e. subsequent attempts to receive the message.

In a further development, temporal error retries are specifically scheduled at times when: (i) success of retrieving the message is likely, (ii) the retry does not interfere with other user activity vis-à-vis the mobile phone—i.e., mobile phone calls, or retrieving or sending of other messages. For example, the successful sending or receiving of a message at a certain time can be taken as an indication that the wireless network is operating smoothly at this time, therefore retries for other pending messages are performed shortly thereafter.

Permanent errors are handled by abandoning the message and alerting the user of an error condition. Temporal errors which have not been resolved after the limited number of retries have been attempted are treated as permanent errors.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements and in which:

FIG. 1 is a block diagram of an MMS-enabled wireless network;

FIG. 2 is a flow chart showing the initial classification of an error relating to an MMS message as temporal or permanent;

FIG. 3 is a state diagram of the message retrieval retry system according to an illustrative embodiment of the present invention; and

FIG. 4 is a flow chart of the method for handling messages in a Ready state according to an illustrative embodiment of the present invention.

### DETAILED DESCRIPTION OF PREFERRED EMBODIMENTS

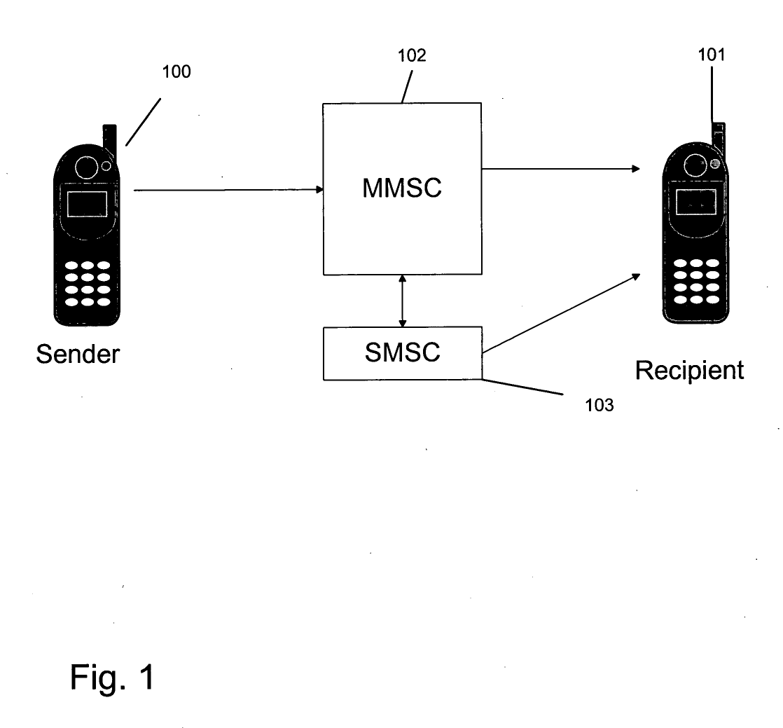

FIG. 1 is a block diagram of an MMS enabled wireless network. This figure only shows certain elements of the wireless network which are relevant to the present invention. Other elements, such as radio towers are omitted for the sake of clarity, and are well known in the art of wireless communications. The embodiment of the present invention described herein is preferably implemented on a CDMA network, e.g., the 1× CDMA or CDMA2000 network, which provides higher speed data connections for MMS message transfer. One skilled in the art will appreciate that the invention is equally applicable to any wireless cellular network that is capable of providing text and multimedia messaging to wireless subscribers and that may experience errors in message transmission.

In FIG. 1 a sender using cellular or mobile phone 100 attempts to send an MMS message to a recipient using mobile phone 101. Mobile phone 100 establishes a data connection to a Multimedia Messaging Service Center (also known in the art as an “MMSC”) 102. The MMSC is a known messaging switch which is used for storing and routing MMS messages in a wireless network. An example of a currently used MMSC is the Multimedia Messaging Center supplied by Telefonaktiebolaget LM Ericsson of Sweden. Once a data connection is established, mobile phone 100 sends the MMS message to MMSC 102. Having received the message, MMSC 102 saves it and examines it to determine the message recipient. After determining the recipient, the MMSC sends a notification message to Short Message Service Center (also known as “SMSC”) 103, the notification message being addressed to recipient's mobile phone 101. The SMSC is a well known messaging switch used in the art for routing text (or short binary) messages in a wireless network. An example of a currently utilized SMSC is the Message Register supplied by Motorola, Inc.

The notification message sent by the MMSC 102 to the SMSC 103 preferably includes some information identifying the MMS message, such as the phone number of the sender and the subject line of the MMS message. The SMSC sends the notification message to recipient's mobile phone 101. Having received the notification message, recipient's mobile phone 101 alerts recipient that an MMS message is pending for the user at the MMSC and provides the user with the opportunity to retrieve the MMS message. If recipient chooses to retrieve the MMS message, mobile phone 101 attempts to establish a data connection to the MMSC 102 to request the MMS message. Alternatively, the mobile phone 101 does not inform the user of the pending message and wait for user authorization, but immediately attempts to establish a data connection and retrieve the message. Errors relevant to the present invention may occur during the process of establishing a data connection and/or retrieving the message.

The present invention is directed to a method and system for handling these errors and is preferably implemented in the recipient's phone 101 using known methods for programming mobile phones and associated operations.

The method for handling errors distinguishes between two types of errors—temporal and permanent. Temporal errors are errors that are due to a condition that is likely to be resolved in the near future in the course of normal operation of a wireless network. Examples of temporal errors are lack of coverage, lack of 1× CDMA coverage, lack of sufficient bandwidth for a new data connection, and MMSC “not responding” errors.

Permanent errors are errors that are not expected to be resolved within a short period of time. Examples of a permanent error are an indication from the MMSC 102 that the message sought to be received is not present at the MMSC, an indication that the user attempting to retrieve the message is not signed up for the messaging service or an indication that the message has been corrupted.

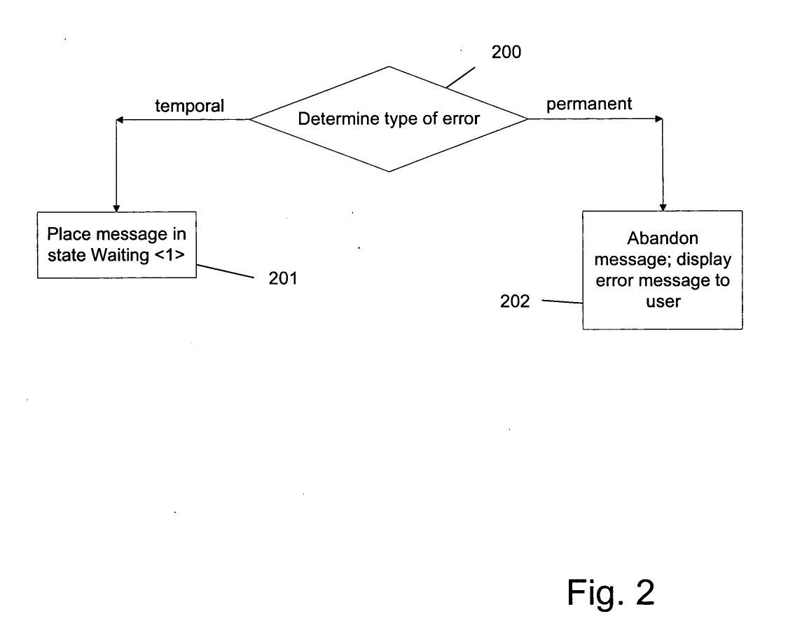

During an attempt to retrieve a message, an error may be detected by the MMSC 102 or by recipient's mobile phone 101. If an error is detected by the MMSC, the MMSC generates an error code that corresponds to the type of error and sends a message including the error code to recipient's mobile phone. If an error is detected by the mobile phone, it also generates an error code corresponding to the type of error. The error is classified by recipient's mobile phone 101 as temporal or permanent based on the error code. FIG. 2 is a flow chart showing this initial classification. At step 200 the type of error (temporal or permanent) is determined. If the error is temporal the message is placed in state Waiting <1> (step 201). The significance of states is explained below. If the error is permanent, the message is abandoned, and an error indication is displayed to the user (step 202).

If a temporal error is detected, re-transmission of the message will be attempted several times. In accordance with an embodiment of the present invention, cellular phones are provided with a value for the maximum number of retries—M. If after M retries have been attempted the message still cannot be delivered, an error message is displayed to the user. The value of M depends on the overall reliability and traffic characteristics of the wireless network. Mobile phones are also configured with a plurality of values W(1) . . . W(M) (assuming M>1). Each value W(i), wherein i is an integer such that 1<=i<=M defines a waiting time which is to elapse before the i-th retry is attempted. Thus, there is a waiting time of W(1) before the first retry attempt, W(2) before the second attempt and so on. It is preferred that the value of W(i) increase as i increases. Exemplary values of W are as follows: W(1)=30 sec., W(2)=3 min. and W(3)=10 min.

In accordance with the present invention, the mobile phone 101 may modify the value of M in response to changes in the load, capacity, or other characteristics of the wireless network. A wireless phone may receive data about the characteristics of a network, from the network itself. Alternatively, a wireless phone may compile statistics about the state of the network by keeping track of times of availability of data services, and the success rate of message transmission. Furthermore, the value of M may be modified depending on the physical location of the mobile phone 101. This feature accommodates the differing characteristics of wireless networks at various locations. Many modern phones have the ability to approximately determine their location. This is most often done by use of global positioning (GPS) systems. Thus, phones may be provided with a table which specifies various values of M for various locations. The values of W(1) . . . W(M) may also change in a similar manner.

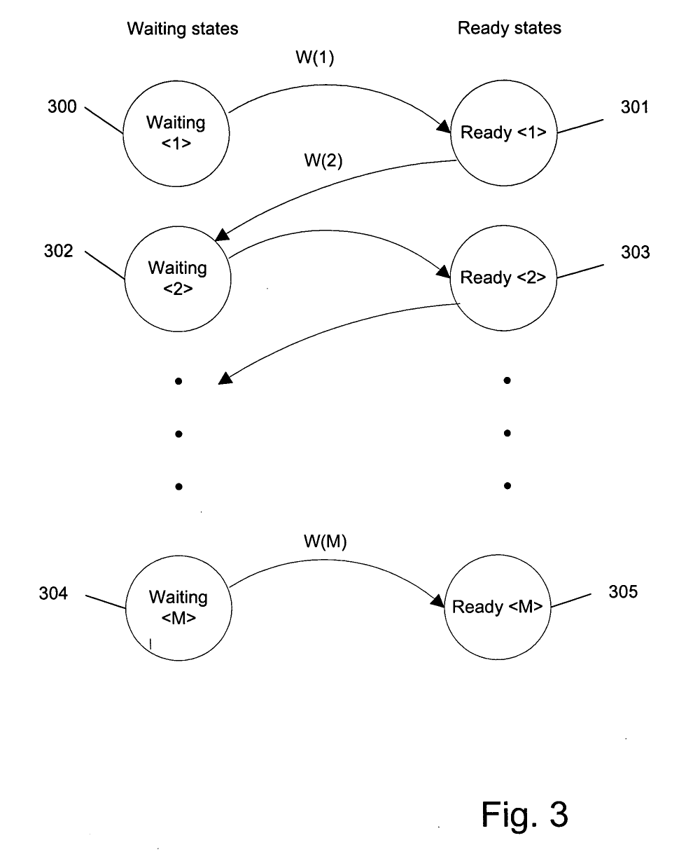

FIG. 3 is a state diagram of the various states of the process for attempting retries of message transmission. The system alternates between one of the waiting states such as states 300, 302, 304 and one of the ready states such as states 301, 303, 305. The message is initially placed in state Waiting 1 (300) on the discovery of a temporal error (see FIG. 2, step 201). A waiting state Waiting <i> changes into a ready state Ready <i> after waiting time W(i) elapses. Thus, state Waiting 1 (300) will change into state Ready 1 (301), after a period defined by W(1).

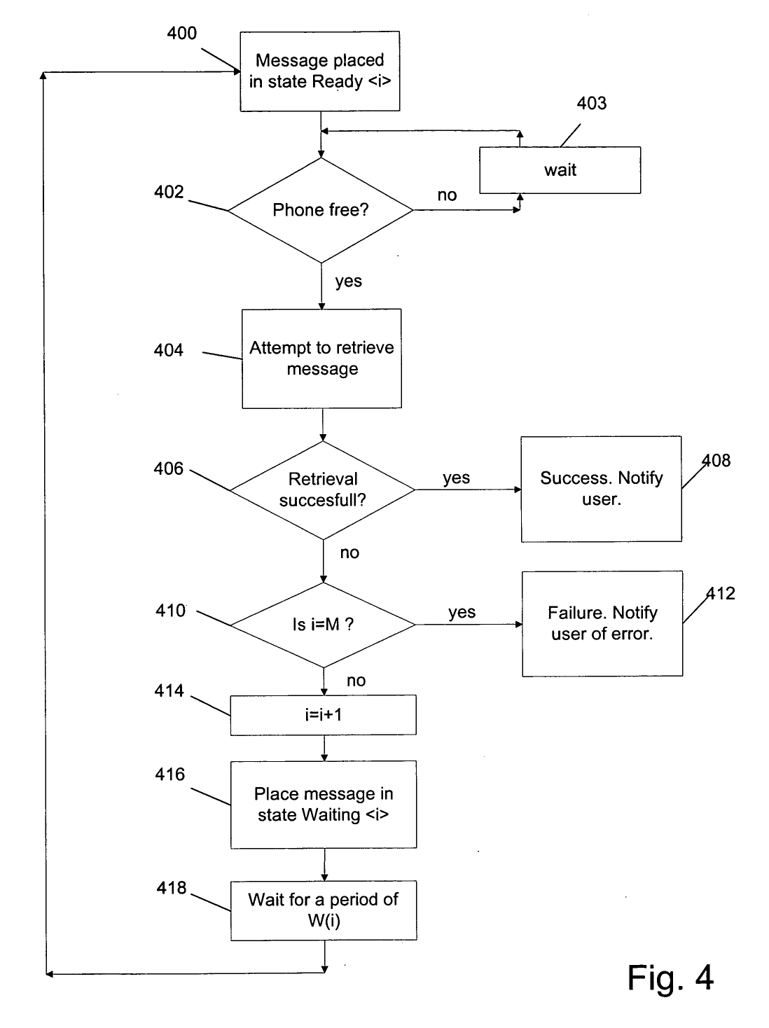

FIG. 4 shows the handling of messages in a Ready state. Beginning with a message placed in a state Ready <i> (step 400), a check is made whether the user is using the mobile phone (step 402). If the user is currently using the mobile phone the message continues to be in the Ready state, and the system waits until the phone is free (steps 403 and 402). If the phone is free, retrieval is attempted (step 404). Step 406 checks if retrieval was successful. If retrieval was successful, the message is removed from the retry queue and the user is alerted of the success (step 408). If retrieval fails, the system checks whether the maximum number of retries have been attempted, i.e., whether i=M (step 410). If that is the case, the message is abandoned and the user is notified of the failure (step 412). If that is not the case, the value of i is incremented (step 414) and the message is placed in the next waiting state (step 416). In light of the incremented value of i, the next waiting state is Waiting <i>. The message remains in this waiting state for a period of W(i) (step 418). After the waiting period has elapsed the message is placed in the next ready state in step 400. Thereafter, the steps shown in FIG. 4, are repeated for the new ready state and the incremented value of i.

If while a first message is undergoing the above described retry procedure, a second message is successfully sent or received and the mobile phone is available thereafter, an attempt to retrieve the first message will be immediately made regardless of the current state of the first message. Thus, even if the first message is in a Waiting state, an attempt to retrieve it will be made. This is done because the successful sending or receipt of the second message signifies that the wireless network is probably performing well. Thus, an opportunity to quickly and successfully retrieve all messages undergoing the retry procedure arises. For this reason, if any message is successfully sent or received, the usual retry procedure is temporarily ignored and sequential retrieval attempts are made for all messages undergoing the retry procedure as long as the mobile phone is available. These retrieval attempts are referred to as opportunity retries.

While the present invention is described in relation to the CDMA network, a person skilled in the art will recognize that the present invention may be easily used with other wireless networks, such as, for example, the GSM network. Thus, when the foregoing description refers to components that are specific to the CDMA network, such as the SMSC and the MMSC, it should be understood that these components are provided as examples only and analogous components associated with other networks may be used instead.

While the foregoing description and drawings represent illustrative embodiments of the present invention, it will be understood that various changes and modifications may be made without departing from the spirit and scope of the present invention.

1. A method for handling wireless messaging errors resulting from an attempted receipt of a message by a wireless telephone comprising the steps of:
receiving a message notification from a first messaging switch, the message notification being associated with a message at a second messaging switch;
initially attempting to retrieve the message from the second messaging switch;
if an error message describing an error condition is received from the second messaging switch, then
classifying the error condition as temporal or permanent; and if the error condition is temporal, then
automatically performing a plurality of retry attempts to retrieve the message, each retry attempt being performed after a corresponding waiting period has passed since the previous attempt to retrieve the message.

2. The method of claim 1, wherein each waiting period is longer than the preceding waiting period.

3. The method of claim 2, wherein each retry attempt comprises the steps of:
determining whether the wireless telephone is currently in use; and
attempting to retrieve the message when the wireless telephone is not in use.

4. The method of claim 3, further comprising the steps of:
determining whether a second message has been successfully sent to or received from the wireless telephone;
upon determination that a second message has been sent or received from the wireless telephone, attempting a retry for the message without waiting the corresponding waiting period.

5. The method of claim 1, wherein the first messaging switch is associated with text messages, and the second messaging switch is associated with multimedia messages.

6. The method of claim 5, wherein the first messaging switch includes an SMSC and the second messaging switch includes an MMSC.

7. The method of claim 1, wherein the wireless telephone is provided with a maximum number of retry attempts and further comprising the step of:
modifying the maximum number of retry attempts.

8. The method of claim 7, further comprising the step of:
modifying the length of one or more of the corresponding waiting periods.

9. A method for handling wireless messaging errors resulting from an attempted receipt of a message by a wireless telephone comprising the steps of:
receiving a message notification from a first messaging switch, the message notification being associated with a message at a second messaging switch;
initially attempting to retrieve the message from the second messaging switch;
if an error message describing an error condition is received from the second messaging switch, then
classifying the error condition as temporal or permanent and if the error condition is temporal then:
automatically performing a first retry attempt to retrieve the message, the first retry attempt being performed after a first waiting period has elapsed after the classifying step;
automatically performing a second retry attempt to retrieve the message, the second retry attempt being performed after a second waiting period has elapsed after the first retry attempt; and
automatically performing a third retry attempt to retrieve the message, the third retry attempt being performed after a third waiting period has elapsed after the second retry attempt.

10. The method of claim 9, wherein the third waiting period is longer than the second waiting period, and the second waiting period is longer than the first waiting period.

11. The method of claim 10, wherein the third waiting period is 10 minutes, the second waiting period is three minutes, and the first waiting period is 30 seconds.

12. The method of claim 9, wherein the first, second and third retry attempts each comprise the steps of:
determining whether the wireless telephone is currently in use; and
attempting to retrieve the message when the wireless telephone is not in use.

13. The method of claim 12, further comprising the steps of:
determining whether a second message has been successfully sent to or received from the wireless telephone;
upon determination that the second message has been sent or received from the wireless telephone, attempting a retry for the message without waiting the corresponding waiting period.

14. The method of claim 9, wherein the first messaging switch is associated with text messages, and the second messaging switch is associated with multimedia messages.

15. The method of claim 14, wherein the first messaging switch includes an SMSC and the second messaging switch includes an MMSC.

16. The method of claim 9, further comprising the step of:
modifying the length of the first, second, and third waiting periods.
